(19) United States
(12) Patent Application Publication
(10) Pub. No.: US 2006/0138874 A1
(43) Pub. Date: Jun. 29, 2006

(54) Motor, motor system, motor elements and method of assembly thereof

(76) Inventors: Stanley W. Janisiewicz, Endwell, NY (US); Koen A. Gieskes, Deposit, NY (US)

Correspondence Address: Schmeiser, Olsen & Watts LLP, 3 Lear Jet Lane, Suite 201, Latham, NY, 12110, US

(21) Appl. No.: 11/356,580

(22) Filed: Feb. 17, 2006

Related U.S. Application Data
(63) Continuation-in-part of application No. 11/013,777, filed on Dec. 16, 2004.

(51) Int. Cl. H02K 41/00

(52) U.S. Cl. 310/12

(57) ABSTRACT

A variable reluctance linear motor comprising a motor system, that includes a bearing assembly and a spacer block that is incorporated into the motor so as to guarantee that an air gap that is maintained between the motor and stator during relative motion there between. The invention further includes means to replace the bearing assembly(s) and winding(s) that can be used with the motor and a method of assembly.

### RELATED APPLICATIONS

This application claims benefit to non-provisional U.S. patent application Ser. No. 11/013,777, filed Dec. 16, 2004.

### BACKGROUND OF THE INVENTION

1. Technical Field

This invention relates to motors and, more particularly to a variable reluctance linear motor, parts thereof, and the assembly thereof.

2. Related Art

Variable reluctance linear motor systems comprising a motor and a stator are well known. As is the fact that a variable reluctance linear motor system requires a small air-gap (e.g., 0.003″ to 0.008″) between the motor and the stator as the motor and the stator move relative to each other in order to aid in optimizing motor force and efficiency. Establishing and maintaining this air-gap is difficult and costly when there is a tolerance buildup over several parts and dimensions. Another issue that variable reluctance linear motor systems encounter is that if a portion of a motor fails, such as a winding, a bearing assembly, and the like, then the whole motor must be replaced.

A need exists for a variable reluctance linear motor system that overcomes at least one of the aforementioned, and, also, other deficiencies in the art.

### SUMMARY OF THE INVENTION

The present invention overcomes the tolerance buildup and the replaceability of portions of a variable reluctance linear motor system by creating a new and unique way of assembling the motor portion of the system out of subassemblies that are easier to machine to final tolerance.

In a first general aspect, the present invention provides a variable reluctance linear motor system comprising: a first body; a second body; a stator, operatively positioned between said first and second bodies, for axial relative movement between said stator and at least one of said first body and said second body; at least one first bearing assembly, replaceably attached, to said first body; at least one second bearing assembly, replaceably attached to said second body; and at least one spacer block, replaceably attached between said first body and second body; wherein a gap is maintained between at least one of the stator and the first body and the stator and the second body.

In a second general aspect, the present invention provides a method of assembling a variable reluctance linear motor, said method comprising: providing a first body; providing a second body; providing a stator, positioned between the first body and said second body for linear slideable relative movement between said stator and said first and second bodies; and replaceably attaching a bearing surface and a spacer block to maintain a gap between both said stator and said first body and stator and said second body.

In a third general aspect, the present invention provides a bearing assembly for use in a variable reluctance linear motor system having a first body, a second body, and a stator, wherein said bearing assembly comprises: a bearing surface, replaceably attachable to either said first body or said second body, configured to maintain a gap between both said stator and said first body and stator and said second body.

In a fourth general aspect, the present invention provides a spacer block for use in a variable reluctance linear motor system having a first body, a second body, and a stator, wherein said spacer block comprises: a surface, replaceably attachable between said first body and said second body, configured to maintain a gap between both said stator and said first body and said stator and said second body.

### BRIEF DESCRIPTION OF THE DRAWINGS

A complete understanding of the present invention may be obtained by reference to the accompanying drawings, when considered in conjunction with the subsequent detailed description, in which:

FIG. 1 is a top, perspective view of an embodiment of an assembled motor, in accordance with the present invention;

FIG. 2 is a close-up perspective view of an embodiment of a bearing assembly in accordance with the present invention;

FIG. 3 is an exploded top, perspective view of a first phase of assembly of an embodiment of the motor in accordance with the present invention;

FIG. 4 is an exploded top, perspective view of a second phase of assembly of an embodiment of the motor in accordance with the present invention;

FIG. 5 is a top, perspective view of a third phase of assembly of an embodiment of the motor in accordance with the present invention;

FIG. 6 is a top, perspective view of an embodiment of a fully assembled motor system, in accordance with the present invention;

FIG. 7 is an end view of an embodiment of a motor system, in accordance with the present invention;

FIG. 8 is a top, perspective view of an embodiment of an assembled motor, in accordance with the present invention;

FIG. 9a is a close-up perspective view of an embodiment of a bearing assembly in accordance with the present invention;

FIG. 9b is a close-up perspective view of an embodiment of a spacer block in accordance with the present invention;

FIG. 10 is an exploded top, perspective view of an embodiment of a first phase of assembly of an embodiment of the motor, in accordance with the present invention;

FIG. 11 is an exploded top, perspective view of an embodiment of a second phase of assembly of an embodiment of the motor, in accordance with the present invention;

FIG. 12 is an exploded top, perspective view of an embodiment of a phase of assembly of an embodiment of the motor in accordance with the present invention;

FIG. 13 is a top, perspective view of an embodiment of a fully assembled motor system, in accordance with the present invention;

FIG. 14 is an end view of an embodiment of a motor system, in accordance with the present invention.

### DETAILED DESCRIPTION OF THE INVENTION

Although certain embodiment of the present invention will be shown and described in detail, it should be understood that various changes and modification may be made without departing from the scope of the appended claims. The scope of the resent invention will in no way be limited to the number of constituting components, the materials thereof, the shapes thereof, the relative arrangement thereof, etc. and are disclosed simply as an example of an embodiment. The features and advantages of the present invention are illustrated in detail in the accompanying drawings, wherein like reference numerals refer to like elements throughout the drawings.

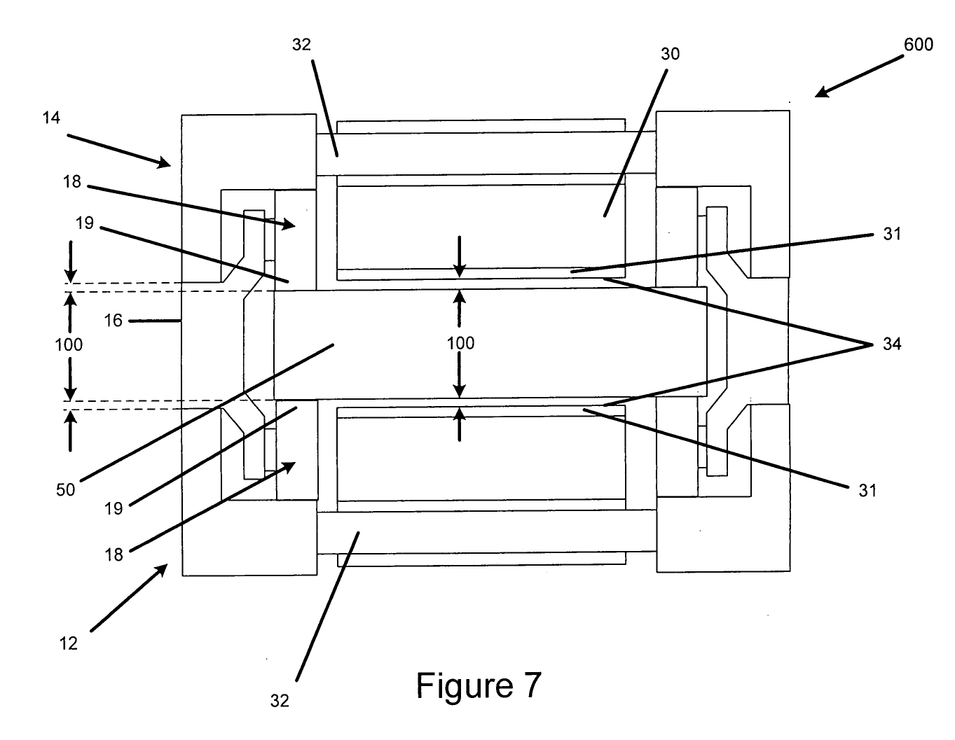

The present invention pertains to a variable reluctance linear motor system comprising a motor and a stator, and more particularly to the motor apparatus, parts thereof, and assembly of the motor. The inventive apparatus of the motor and the assembly method thereof provides a cost effective and less complicated manner in which to create and maintain an air-gap 100 (see FIG. 7) in the range of approximately 0.003″ to 0.008″ between the motor and the stator as one moves relative to the other by eliminating the tolerance buildup over several parts and dimensions. Reducing the number of individual parts having critical dimensions in the motor reduces the overall cost of the motor, as well. The apparatus and method of assembly of the motor also allows for replacement of individual parts of the motor in case of failure without having to replace the entire motor.

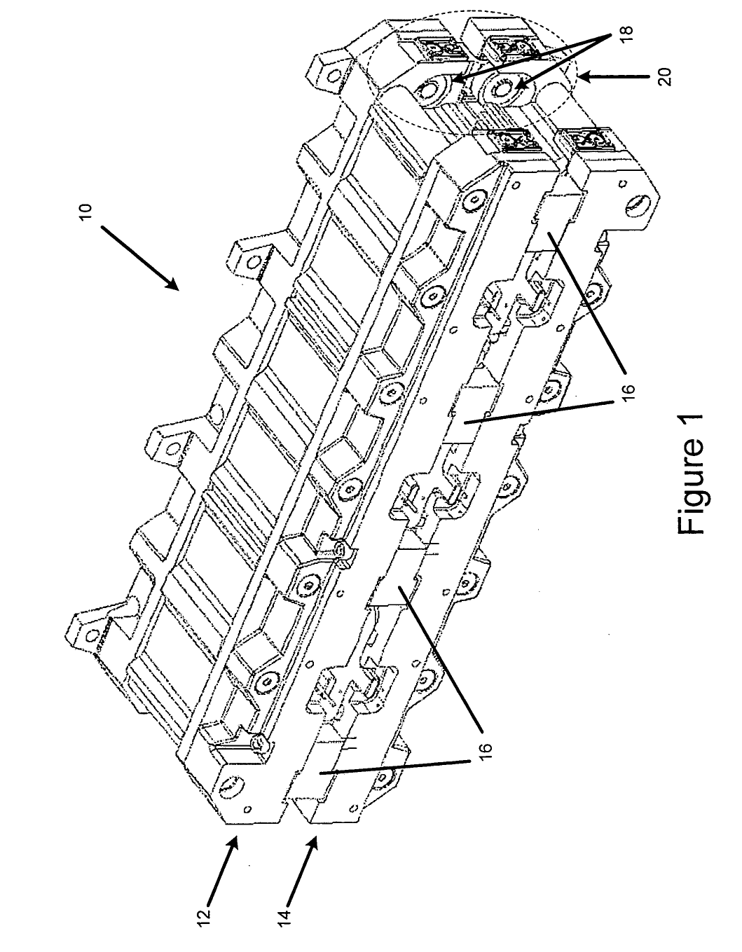

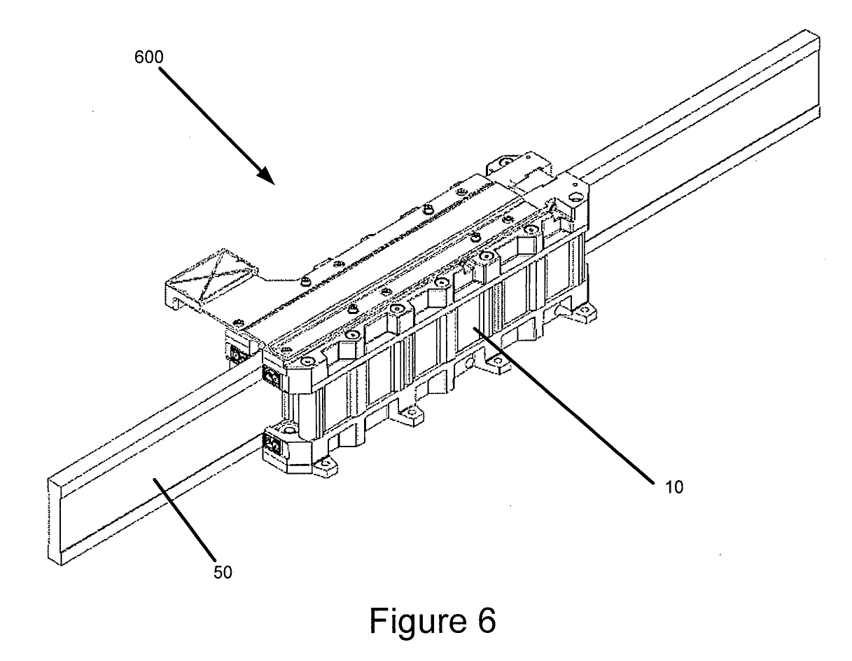

Turning now to FIG. 1, which depicts an embodiment of a motor 10 of the present invention, said motor 10 comprising at least two bodies, a first body 12, and a second body 14. The first and second bodies 12, 14 may be plate-like in configuration. Located between and separating the first and second bodies 12, 14, are a plurality of bearing members, or assemblies 20. The bearing assembly 20 include a spacer block 16 that creates a space between the first body 12 and the second body 14 when assembled and allows for the passage of a stator 50 (See FIG. 6) through motor 10. The bearing assembly 20 are releasably attached to the first and second bodies 12, 14. The bearing assembly 20 further includes a plurality of bearing surfaces 19 that in one embodiment are provided from a plurality of roller bearings 18. The bearing assembly 20 is manufactured such that as the stator 50 rides on the bearing surfaces 19 of the rollers bearings 18, wherein an air-gap 100 (See FIG. 7) in the range of approximately 0.003″-0.008″ is maintained between the motor 10 and the stator 50.

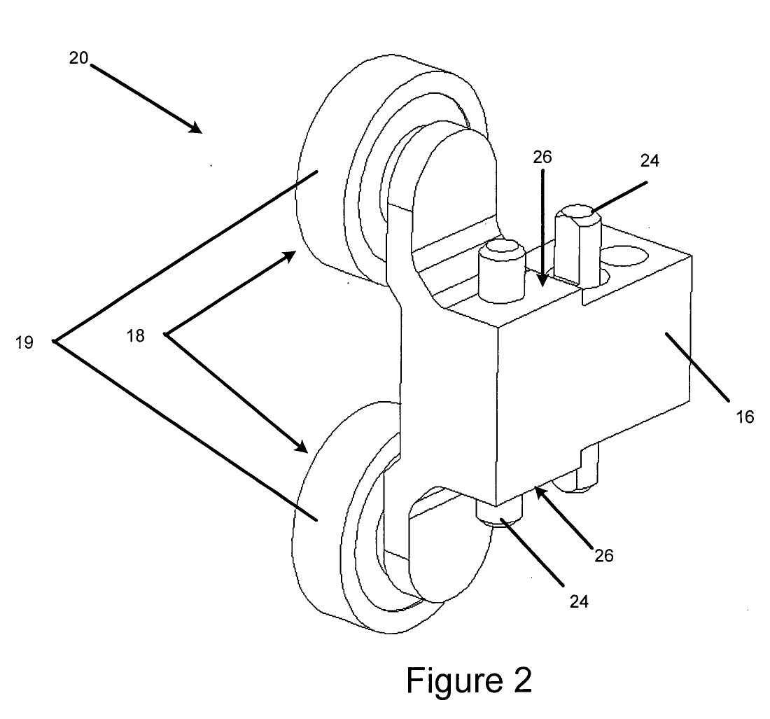

FIG. 2 depicts a close-up view of one embodiment of a bearing member, or assembly 20, which comprises two roller bearings 18 mounted on the spacer block 16. The two roller bearings 18 include two bearing surfaces 19. The bearing assembly 20 also includes locating pins 24 inserted through the spacer block 16. The bearing assembly 20 is manufactured such that the distance between bearing surfaces 19 is precisely maintained, and surfaces 26 are precisely machined. The locating pins 24 are for alignment of the bearing assembly 20 between the first body 12 and second body 14 when assembling motor 10. Bearing assembly 20 contains the dimensions such that when the bearing assembly 20 is assembled between the first body 12 and the second body 14 to create motor 10, an air-gap 100 (See FIG. 7) in the range of approximately 0.003″-0.008″ will be created and maintained between the motor 10 and the stator 50 as one moves relative to the other.

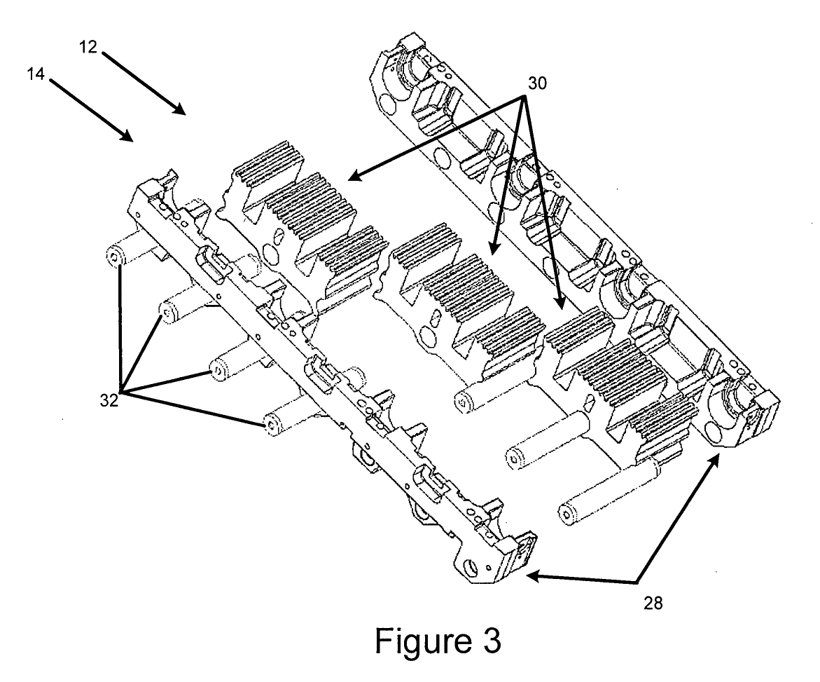

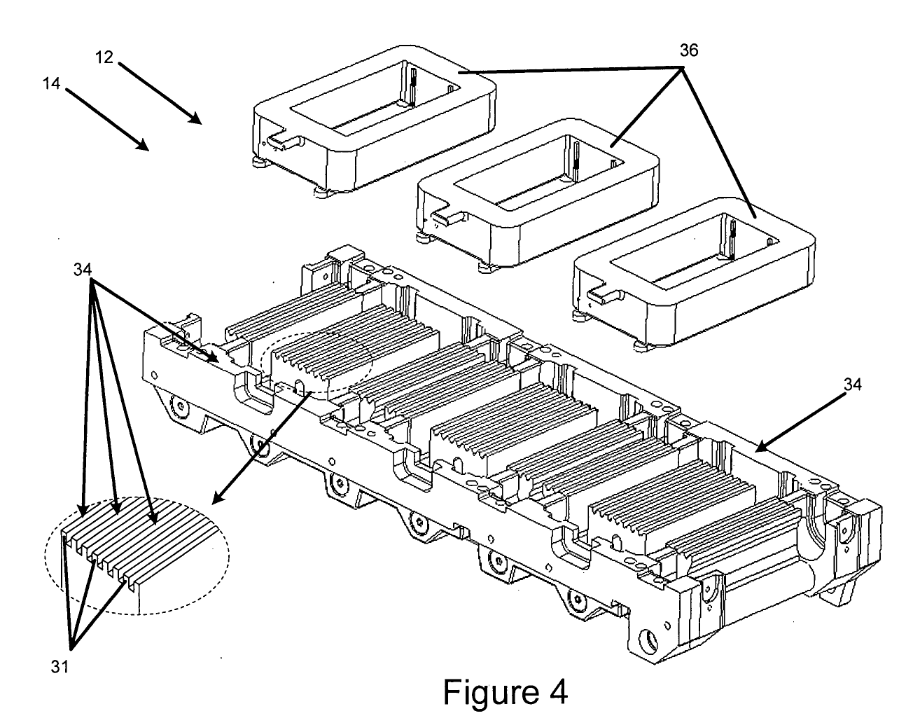

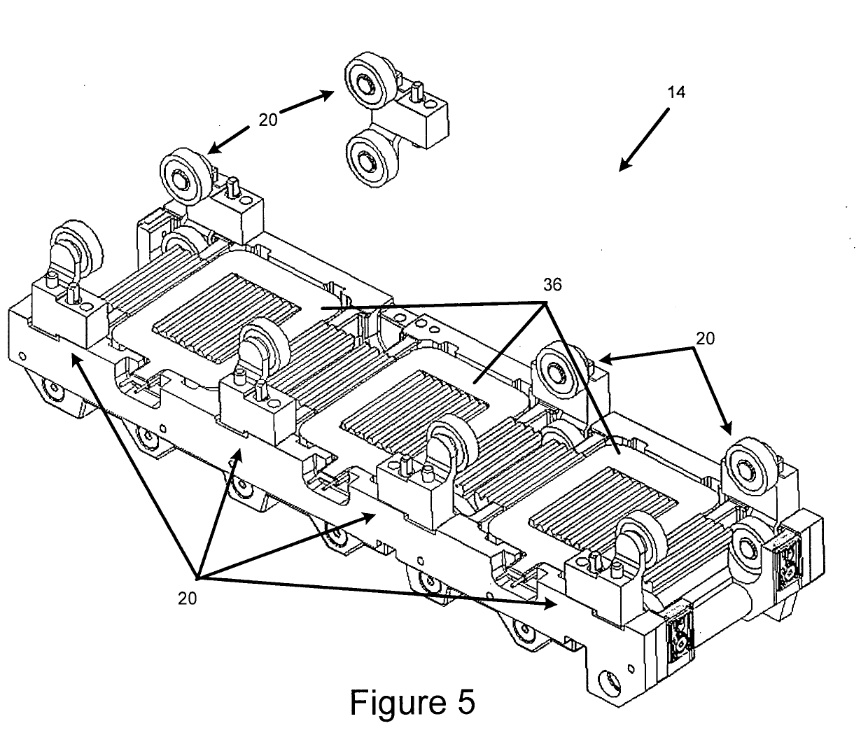

Referring now to FIGS. 3-5, these show the various stages of the assembly of motor 10. Similarly, the figures also show the method of disassembly and/or methods of replacing various elements, or parts, of the motor 10. The first stage of assembly of motor 10 comprises assembling the first body 12 and the second body 14. First body 12 and second body 14 comprise sides 28, motor cores 30, and rods 32. The motor cores 30 comprise stacks of laminations. The first body 12 is assembled as follows. Rods 32 are fit into one of sides 28. The laminations are then stacked on the rods 32 to create the motor core 30. Following creation of motor core 30, the remaining side of sides 28 is fit on to the other side of rods 32. This partial assembly of first body 12 is impregnated in adhesive and heat-treated, then surfaces 34 of both teeth 31 and top of sides 28 are precisely machined typically with a grinder to create a flat surface within +/−0.00025″. Then machined into sides 28 are any remaining features, such as the holes for locating pins 24 and slots for bearing assembly 20. Windings 36 assembled on to the motor cores 30 complete the assembly of first body 12 of motor 10. Assembly of the second body 14 of motor 10 follows the above-described process described. Next added to second body 14 are bearing assemblies 20. Lastly, assembly of first body 12 onto the second body 14 completes the assembly of motor 10. The machined surfaces 26 on spacer block 16 of bearing assembly 20 mate with machined surfaces 34 of first body 12 and second body 14.

It should be apparent to one skilled in the art that although the above described embodiments include roller bearings 18 as part of the bearing assembly 20, there are other configurations that are possible. For example, other bearing types (e.g., ball/needle bearings, etc.) may be used to provide a suitable bearing surface 19.

It should be further apparent to one skilled in the art, that due to the capability to assemble and/or disassemble the motor 10 as discussed, effectively most all parts of the motor 10 can be readily accessed for replacement. As a result, for example, a winding 36, or several windings 36, can be replaced if necessary without the need to replace an entire motor 10 assembly as can be the bearing assemblies 20.

Turning to FIG. 6, which shows a perspective view of a motor 10 and stator 50. The motor 10 and stator 50 move relative to each other. That is either the stator 50 is stationary, while the motor 10 moves or the motor 10 is stationary while the stator 50 moves.

Finally, FIG. 7 shows an end view of a motor 10 and stator 50 and the air-gap 100 located between the surfaces 34 of the teeth 31 of the motor core 30 of the first body 12 and the second body 14 and the surfaces on the stator 50. The distance of the air gap 100 between motor 10 and stator 50 is approximately 0.003″-0.008″.

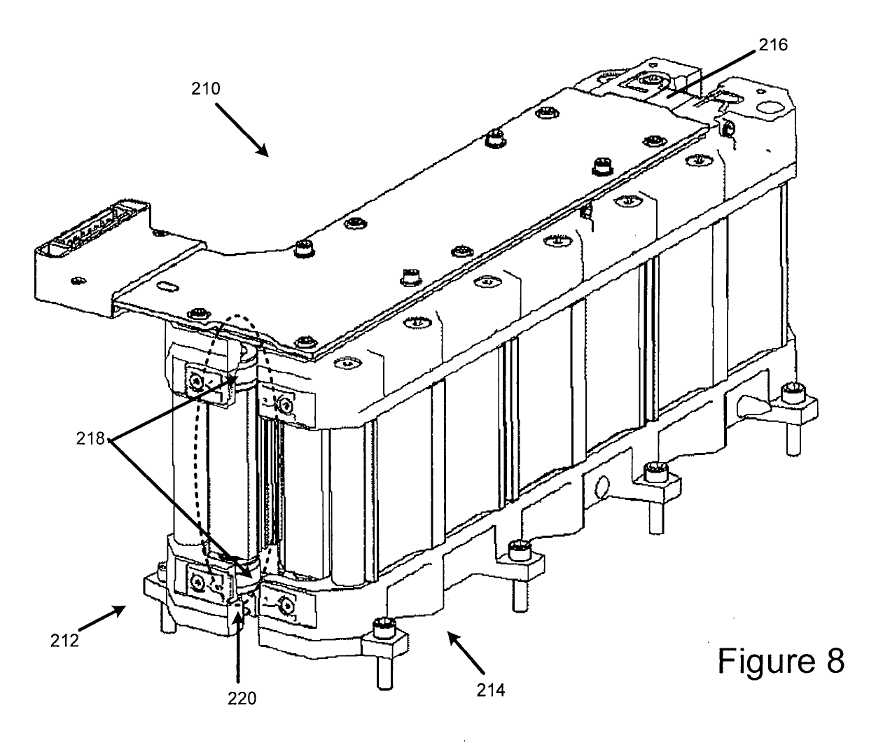

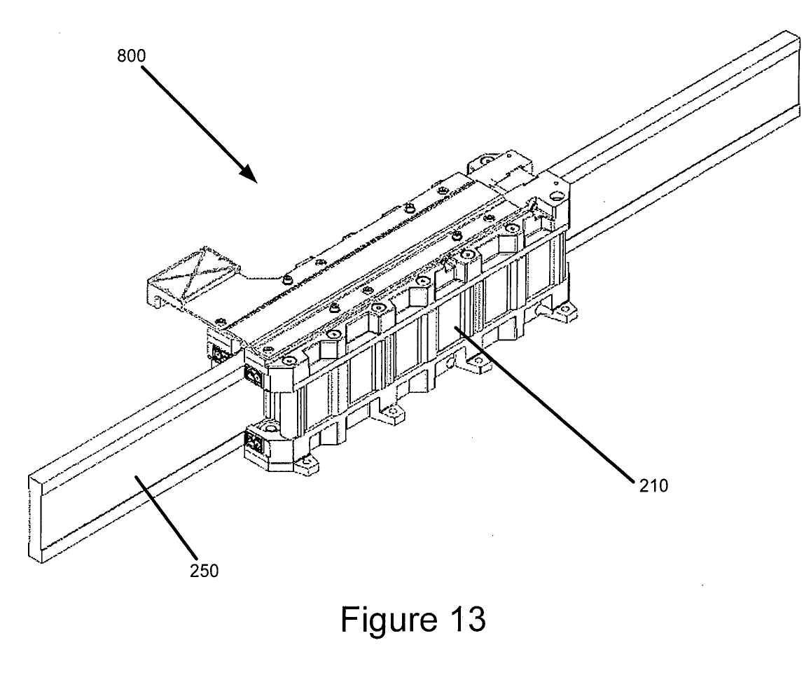

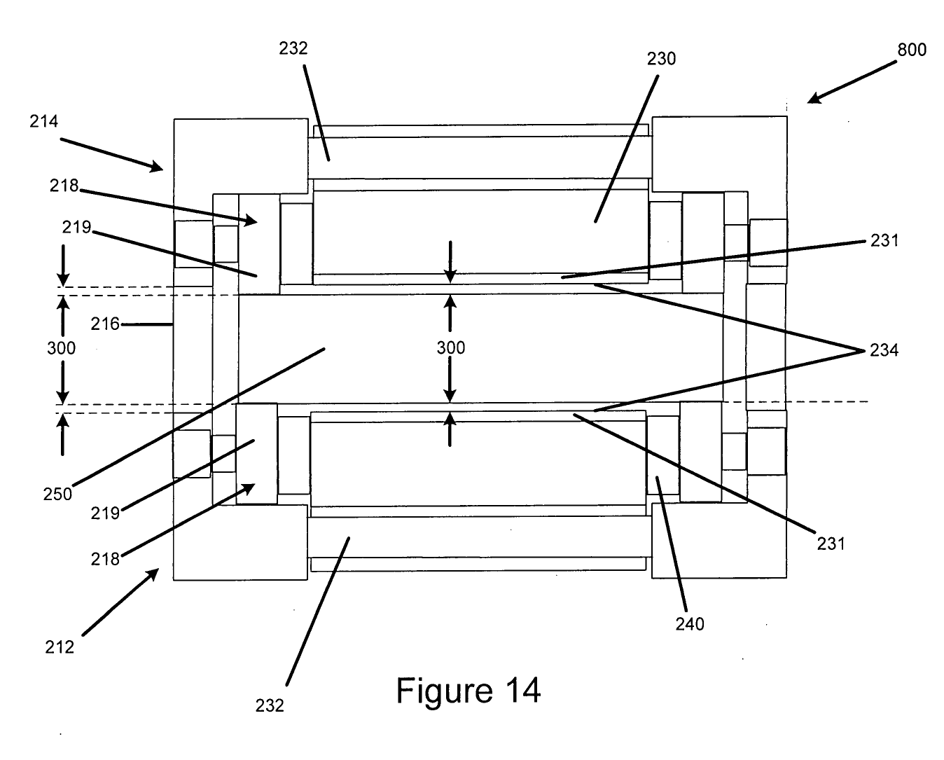

Turning now to FIG. 8, which depicts another embodiment of a motor 210 of the present invention, said motor 210 comprising at least two bodies, a first body 212, and a second body 214. The first and second bodies 212, 214 may be plate-like in configuration. For example, first and second bodies may be formed having a prominent planar assembly arrangement and/or having a face, surface or combined surfaces that may be relatively oriented in parallel planes. Moreover the first and second bodies 212, 214 may serve, in some measure to protect additional features of the motor 210, in a sense, shielding other motor 210 components. Located between and possibly separating the first and second bodies 212, 214, may be one or more spacer blocks 216. A spacer block 216 may create a space or dimensional expanse between the first body 212 and the second body 214 when assembled and may allow for the passage of a stator 250 (See FIG. 14) through motor 210. The spacer blocks may also be formed integrally with one of the first or second bodies 212, 214. In addition, one or more bearing assemblies 220 may be releasably attached to the first and/or second bodies 212, 214. For example a first bearing assembly 220a may operate with the first body 212 and a second bearing assembly 220b may operate with the second body. As depicted, the dashed lines relative to the bearing assembly 220 of FIG. 8 are intended to illustrate a generalized location of an embodiment of a bearing assembly 220. The bearing assembly 220 and spacer blocks 216 may be manufactured such that as a stator, such as the stator 250 (shown in FIG. 13) operates with the bearings 218, an air-gap 300 (See FIG. 14) in the range of approximately 0.003″-0.008″ may be maintained between the motor 210 and the stator 250.

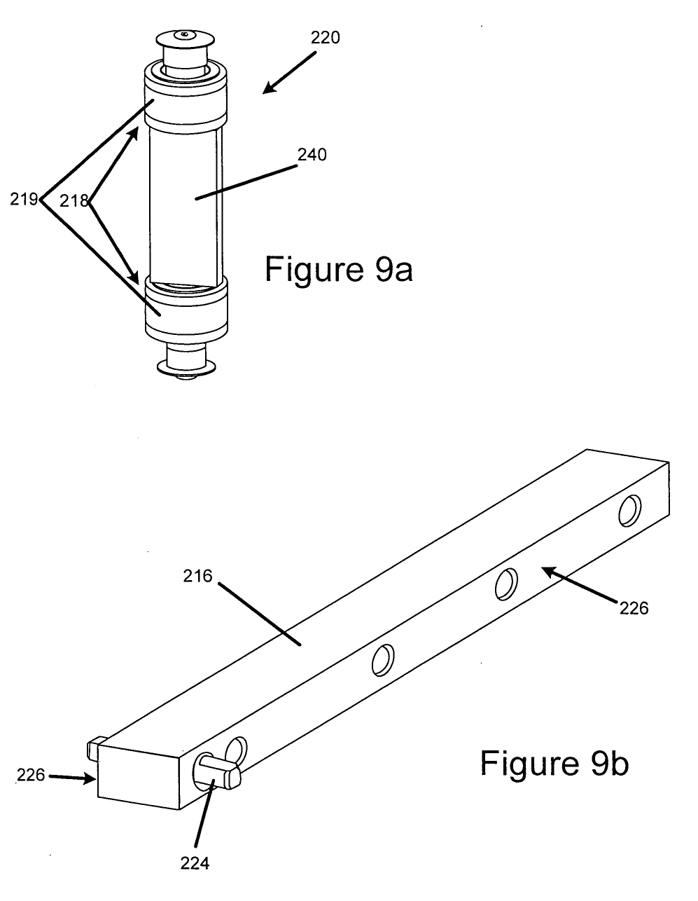

FIGS. 9a and 9b depict a close-up view of one embodiment of a bearing member, or assembly 220 and spacer block 216. The bearing member or assembly 220 may further include a plurality of bearing surfaces 219 that in one embodiment may correspond to the surface of a plurality of roller bearings 218. For example, bearing assembly 220 may comprise two roller bearings 218 mounted on the opposite ends of spacer 240 and may accordingly include two bearing surfaces 219. The spacer 240 may be dimensioned such that the location of bearings 218 may correspond with a surface of the stator 250 (shown in FIG. 13). The bearing assembly 220 may be replaceably attachable to the first body 212 and/or the second body 214, and may be configured to maintain a gap between the stator 250 and first body 212 and the stator 250 and the second body 214. Those in the art may appreciate that other common bearings having comparable operation may be incorporated into the bearing assembly 220 and may be configured to operate with a stator, such as stator 250. In addition, the spacer block 216 may include locating pins 224 that may be inserted through the spacer block 216. However, those in the art should appreciate that the pins 224 may be formed integrally with the block 226. The spacer block 216 may be manufactured such that surfaces 226 are precisely machined. Moreover, the spacer block may include a surface, such as surface 226, that may be replaceably attachable between the first body 212 and the second body 214, and may also be configured to maintain a gap between both the stator 250 (shown in FIG. 13) and the first body 212 and the stator 250 and the second body 214. The locating pins 224 may provide alignment of the spacer block 216 between the first body 212 and second body 214 when assembling motor 210 and when the motor 210 is fully assembled. Additionally, the spacer block 216 may include detents or holes that may correspond with pins operable with the first and or second bodies 212 and 214. Spacer block 216 may also be dimensioned such that when the spacer block 216 is assembled between the first body 212 and the second body 214, an air-gap 300 (See FIG. 14) in the range of approximately 0.003″-0.008″ may be created and maintained between the motor 210 and the stator 250 as one moves relative to the other. Furthermore, surfaces 226 may include surface features that may facilitate additional alignment for the spacer block 216 and other components during motor 210 assembly and operation.

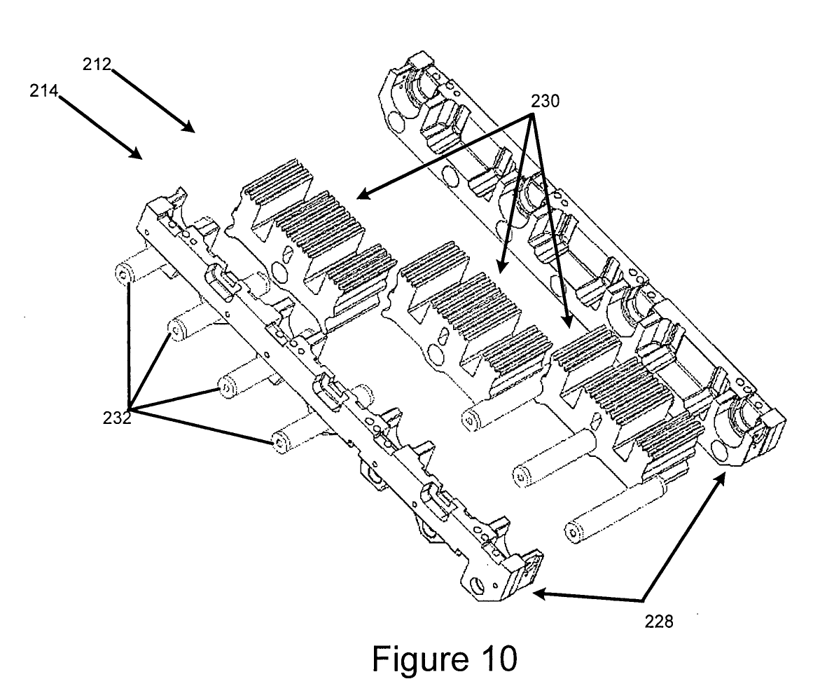

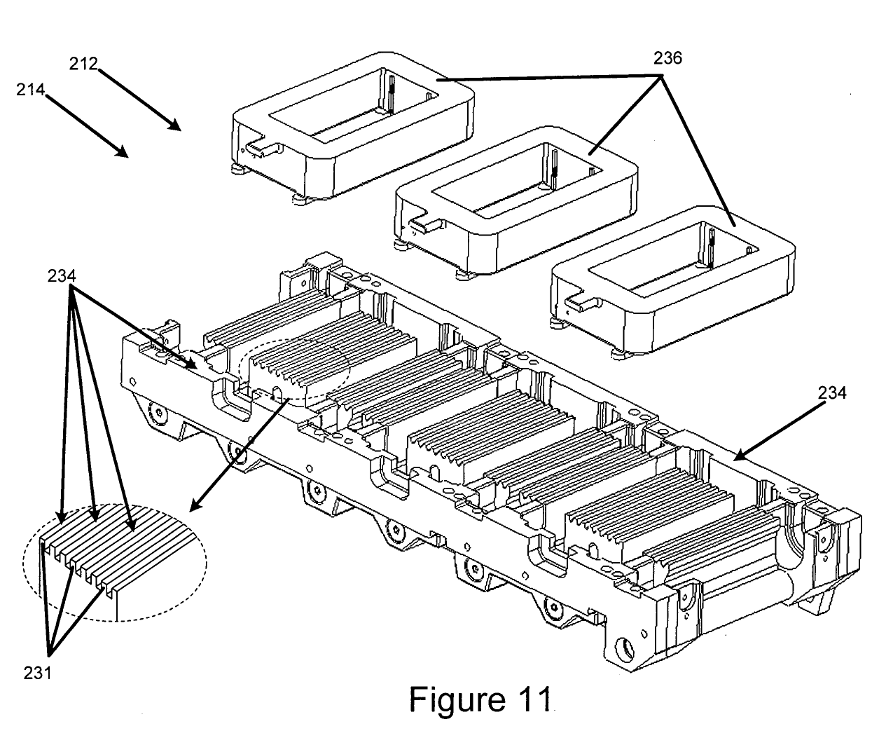

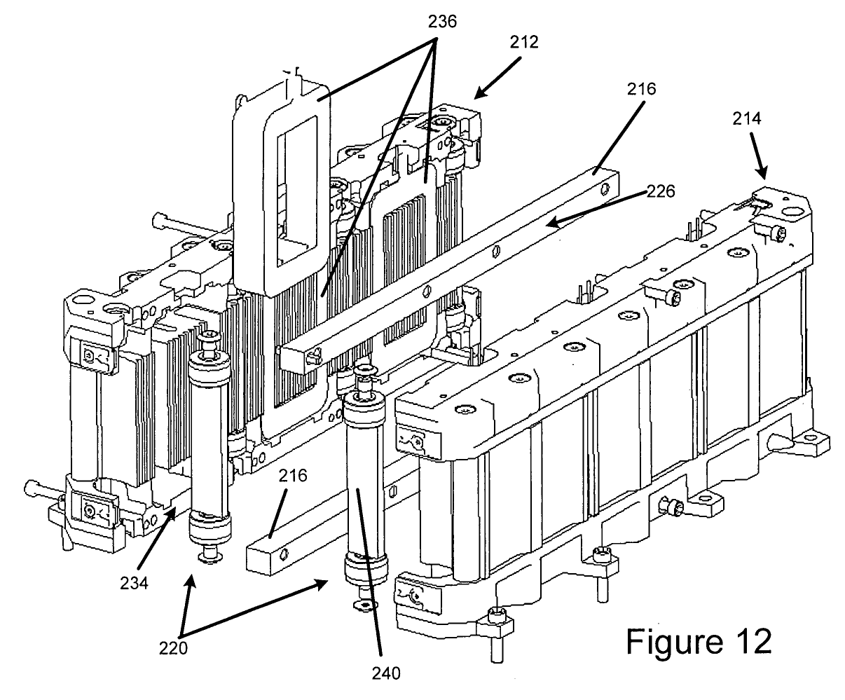

Referring now to FIGS. 10-12, shown are embodiments of various stages of the assembly of motor 210. Similarly, the figures also further depict methodological embodiments of component orientation during disassembly and/or methods of replacing various elements, or parts, of the motor 210. A first stage of assembly of motor 210 may comprise assembling the first body 212 and the second body 214. First body 212 and second body 214 may comprise sides 228, or lengthwise body members, motor cores 230, and rods 232. The motor cores 230 may further comprise stacks of laminations. An embodiment of the first body 212 may be assembled as follows. In general, the component elements of the first body may be positioned in relatively parallel planes and then brought together such that the component elements come into planar alignment. However, non-planar orientation may also be incorporated. Rods 232 may be fit into corresponding sockets formed one of sides 228. The motor core laminations may then be stacked on, or positioned with the rods 232 to create a collective motor core 230. Following formation of the motor core 230, the remaining side of sides 228 may be fit on to, or positioned with the other side of rods 232. The formation of the collective motor core 230 located between two sides 228 and positioned with rods 232 may represent a partial assembly of first body 212 and may be impregnated in adhesive and may also be heat-treated. Moreover, the surfaces 234 in part formed of both teeth 231 and top of sides 228 of the first body 212, may be precisely machined, such as with a grinder or other comparable instrument to create a flat/planar surface within +/−0.00025″ tolerance. Additional surface features, such as the holes for locating pins 224 and slots for bearing assembly 220 may also be machined into the sides 228. Further assembly of the first body 212 may include the positioning of windings 236 into operable position with the motor cores 230.

Assembly of an embodiment of the second body 214 of motor 210 may occur similar to the assembly of first body 212. Accordingly, assembly of an embodiment of the second body 214 may follow the assembly process described above in relation to the first body 212.

Assembly of an embodiment of a motor 210 may further include positioning at least one bearing assembly 220 with the first and/or second bodies 212, 214. The positioning may include securely affixing the bearing assembly 220 to either or both of the first and/or second bodies 212, 214. Moreover, spacer blocks 216 may also be positioned with the first and/or second bodies 212, 214. Additional assembly may include the locating and alignment of pins and other components that may operate with or between the first and second bodies 212, 214. Still further, assembly of a motor 210 may include assembling the first body 212 onto the second body 214. The assembling of the first body 212 and second body 214 may involve the positioning of complimentary surfaces of the first body 212 and second body 214 in substantially parallel planar arrangement. When in substantial planar arrangement, the machined surfaces 226 on spacer block 216 may mate with machined surfaces 234 of first body 212 and second body 214. Operably located between the first and second bodies 212, 214 may be a stator 250 (shown in FIG. 13). Once securely positioned in substantially planar arrangement the assembly of motor 210 may be completed. Those in the art may appreciate that the positioning and assembly of all component elements of motor 210 may be accomplished via machine, such as automated and/o robotic, positioning means, through human positioning or through a combination of human and machine positioning means.

With further reference to the drawings, FIG. 13 shows a perspective view of a motor system 800 comprising motor 210 and stator 250. The motor 210 and stator 250 may move relative to each other. That is the stator 250 may be stationary, while the motor 210 moves or the motor 210 may be stationary while the stator 250 moves. The movement of the stator 250 with the motor may be such that the components maintain planar positioning during movement. In other words, the components may remain substantially fixed with respect to each other as oriented in at least one conjunctive plane.

With continued reference to the drawings, FIG. 14 shows an end view of a motor 210 and stator 250. Also depicted is an air-gap 300 that may be located between the surfaces 234 of the teeth 231 of the motor cores 230 of the first body 212 and the second body 214 and the surfaces on the stator 250. The distance of the air gap 300 between motor 210 and stator 250 may be maintained at approximately 0.003″-0.008″. The air gap may extend or be perpetuated the entire length of the motor 210 such that the gap is maintained as the motor 210 moves in relation with the stator 250.

Since other modification and changes varied to fit particular operating requirements and environments will be apparent to those skilled in the are, the invention is not considered limited to the example chosen for purposes of disclosure, and covers all changes and modification which do not constitute departures from the true spirit and scope of this invention. Although the invention has been described in connection with specific embodiments, outlined above, it should be understood that the invention should not be unduly limited to such specific embodiments. Various changes may be made without departing from the spirit and scope of the invention as defined in the following claims.

What is claimed is:

1. A variable reluctance linear motor comprising:
a first body;
a second body;
a stator, operatively positioned between said first and second bodies, for axial relative movement between said stator and at least one of said first body and said second body;
at least one first bearing assembly, replaceably attached, to said first body;
at least one second bearing assembly, replaceably attached to said second body; and
at least one spacer block, replaceably attached between said first body and second body;
wherein a gap is maintained between at least one of the stator and the first body and the stator and the second body.

2. The motor of claim 2, wherein said at least one bearing assembly further comprises at least one bearing.

3. A method of assembling a variable reluctance linear motor, said method comprising:
providing a first body;
providing a second body;
providing a stator, positioned between the first body and said second body for linear slideable relative movement between said stator and said first and second bodies; and
replaceably attaching a bearing surface and a spacer block to maintain a gap between both said stator and said first body and stator and said second body.

4. The method of claim 4, wherein said bearing surface includes at least one bearing.

5. A bearing assembly for use in a variable reluctance linear motor system having a first body, a second body, and a stator, wherein said bearing assembly comprises:
a bearing surface, replaceably attachable to either said first body or said second body, configured to maintain a gap between both said stator and said first body and said stator and said second body.

6. A spacer block for use in a variable reluctance linear motor system having a first body, a second body, and a stator, wherein said spacer block comprises:
a surface, replaceably attachable between said first body and said second body, configured to maintain a gap between both said stator and said first body and said stator and said second body.
